(19) United States
(12) Patent Application Publication
(10) Pub. No.: US 2011/0190988 A1
(43) Pub. Date: Aug. 4, 2011

(54) METHOD AND CONTROL UNIT FOR ACTIVATING PASSENGER PROTECTION MEANS FOR A VEHICLE

(76) Inventors: Christof Kaerner, Albershausen (DE); Vincent Judalet, Ludwigsburg (DE); Alfons Doerr, Stuttgart (DE); Josef Kolatschek, Weil Der Stadt (DE); Marcus Hiemer, Kehlen (DE); Olaf Koerner, Ludwigsburg (DE)

(21) Appl. No.: 12/735,135

(22) PCT Filed: Nov. 19, 2008
(86) PCT No.: PCT/EP2008/065791

§ 371 Date: Apr. 4, 2011

(30) Foreign Application Priority Data
Jan. 7, 2008 (DE) 10 2008 003 339.1

(51) Int. Cl. B60R 21/0132

(52) U.S. Cl. 701/46

(57) ABSTRACT

In a method for activating a passenger protection unit for a vehicle, features are generated from at least one sensor signal of a crash sensor system. Furthermore, a difference of a feature vector with a first threshold value is formed. This difference is weighted as a function of at least one of the features. The passenger protection unit is subsequently activated as a function of a comparison of a variable, derived from the weighted difference, with a second threshold value.

### BACKGROUND OF THE INVENTION

1. Field of the Invention

The present invention relates to a method and a control unit for activating passenger protection means for a vehicle.

2. Description of Related Art

It is already known from published German patent document DE 103 60 893 A1 to provide a method for activating passenger protection means in which a time-dependency is avoided. Threshold value surfaces are used which are determined by value pairs of velocity reduction and a deceleration. A forward displacement is initially assigned to these value pairs, so that a surface is thus defined in a three-dimensional space.

### BRIEF SUMMARY OF THE INVENTION

The method and the control unit according to the present invention for activating passenger protection means for a vehicle have the advantage over the related art in that the activation of the passenger protection means takes place not only as a function of exceeding a threshold once, but rather because of a threshold value being exceeded multiple, differently weighted times. This makes it possible to set the triggering threshold lower than was previously possible. In particular, better triggering times are possible. Moreover, despite a lower threshold value which must be exceeded for the activation, a robust activation is made possible.

Exceeding a threshold value twice results from the fact that two different threshold values must be exceeded to obtain an activation. On the one hand, a first threshold value, for example in an acceleration-velocity diagram, and a further threshold value which results from a weighted difference from the first threshold value comparison, this weighted difference having been further signal-processed.

In the present case, a control unit means an electrical device which processes a sensor signal and as a function thereof generates a control signal for the passenger protection means such as airbags, seatbelt tighteners, but also for active passenger protection means such as brakes and an electronic stability program. Controlling these passenger protection means is to be understood to mean that these passenger protection means are activated.

An interface here means a hardware and/or software design for providing a sensor signal. This interface, in a hardware design, may be an integrated circuit or a plurality of integrated and discrete circuits. It is possible that the interface is present as a software module, e.g., on a microcontroller or another processor-type electrical module.

The at least one sensor signal may be a single raw data signal or a plurality of such signals or a pre-processed signal which has been filtered, for example. The sensor signal may be an acceleration signal or a signal derived therefrom, a structure-borne noise signal or a signal derived therefrom, an air pressure signal or a signal derived therefrom, or a surroundings signal or a signal derived therefrom. Surroundings signals include, for example, the relative velocity, the impact velocity, and other data detectable by a surroundings sensor. This means that a crash sensor system is understood to be not only an impact sensor such as an acceleration sensor, a structure-borne noise sensor or an air pressure sensor, but also a surroundings sensor. Such surroundings sensor systems include the video, lidar, and ultrasound sensors in addition to the radar sensor. Further better known sensor systems may also be appropriately used here.

An analyzer circuit may be understood to be implemented as hardware and/or software, this analyzer circuit having individual modules such as the feature module, the difference module, the weighting module, and the comparator module. These modules may also be designed as hardware and/or software. This modularity enables efficient splitting of the individual tasks to execute the method according to the present invention. The analyzer circuit may be composed of a processor such as a microcontroller or microprocessor or of an ASIC or also of discrete components. Multi-core type computers are also possible here.

For example, the feature module generates the features from the at least one sensor signal by single or double integration or by averaging or by smoothing.

The difference module forms the difference between the feature vector, which is formed from the features, and a first threshold value. This threshold value may be adaptive or fixedly predefined. The type of difference may also be different. It may be a vector itself, a surface or also a one-dimensional distance between the threshold value and the vector.

The weighting module weights the difference between the threshold value and the feature vector as a function of at least one of the features. This may be implemented by multiplication or other mathematical methods.

The comparator module executes a second threshold value comparison of a variable, derived from the weighted difference, and a second threshold value. This second threshold value may also be adaptive or fixedly predefined, as set forth in the dependent claims. A robust activation method is implemented due to this two-tier threshold value query.

The activating circuit is integrated with the interface on a system ASIC, for example. Different functions of the control unit may be integrated on this system ASIC. In the case of activating active passenger protection means, such as an electronic stability program, the activating circuit is designed as an interface for data transmission, for example as a bus controller.

It is advantageous that the variable is generated by integrating the weighted difference. This integration may be implemented in various ways. For example, this integration may be implemented as a window integral, as summation, as weighted summation or by using other discrete integration methods. The integrated signal may optionally be limited to positive values.

Moreover, it is advantageous that the weighting is carried out by multiplying the difference with one of the features.

In addition, it is advantageous that the second threshold value changes as a function of one of the features and/or the time. This makes it possible to address special situations, known from road tests, in order to take their progress, which is known, into account. This results in a robust activation of the passenger protection means.

It is also advantageous that the feature vector is formed from an acceleration and a velocity as the features. The processing and interpretation of such features is accurate and robust due to the great experience in using these features.

It is also advantageous that the acceleration is used as one of the features. The acceleration and the deceleration, which occur in a crash, have a plurality of pieces of information with regard to the impact and thus provide a meaningful feature for the assessment of whether or not an activating case exists.

The first threshold value may advantageously make a distinction between an activating case and a non-activating case or between crash types or between crash severities. The non-activating case is an impact where no activation is necessary, since this non-activating case is an impact at low velocity. The assessment according to crash types enables an accurate analysis and counter measures which are helpful to provide the vehicle's occupants with optimum protection. The distinction between crash severities also enables an adaptive adjustment of the activation of the passenger protection means. A crash severity is to be understood as the force impacting the vehicle's occupant. The crash severity may thus be determined from the features, for example.

### BRIEF DESCRIPTION OF THE SEVERAL VIEWS OF THE DRAWING

FIG. 1 shows a block diagram of the control unit according to the present invention in the vehicle having connected components.

FIG. 2 shows a flow chart of the method according to the present invention.

FIG. 3 shows two acceleration diagrams with and without use of the present invention.

### DETAILED DESCRIPTION OF THE INVENTION

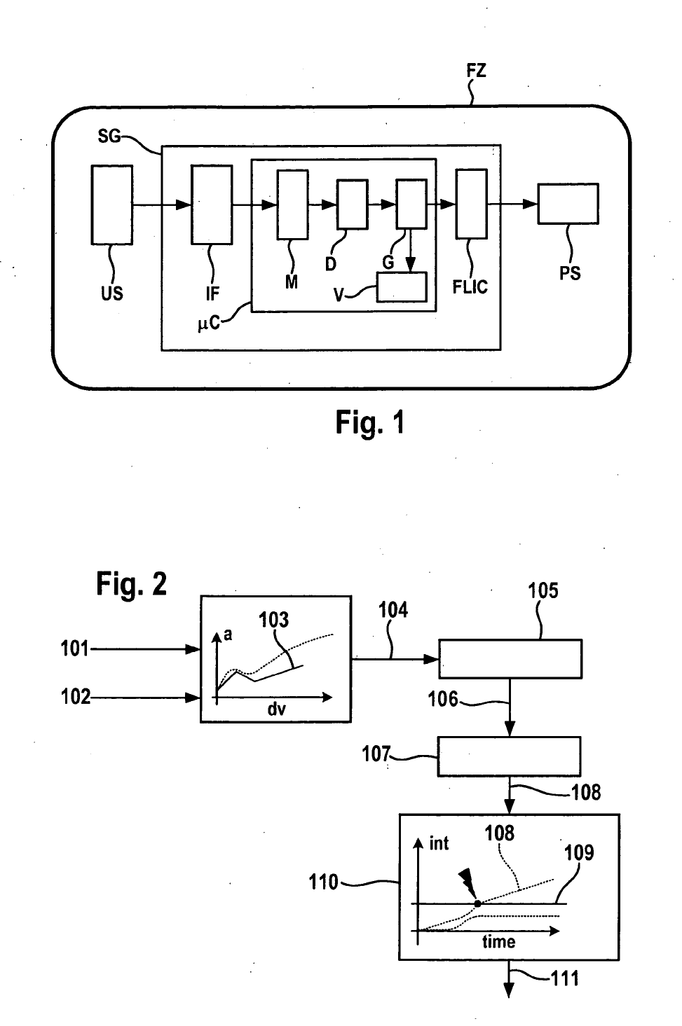

FIG. 1 shows in a block diagram a control unit SG according to the present invention in a vehicle FZ having the connected components, namely crash sensor system US and passenger protection means PS. For the sake of simplicity, only those components are depicted which are necessary to understand the present invention. Additional components, such as a power supply, etc., are necessary for the actual operation of control unit SG, these components having been omitted for the sake of simplicity.

Control unit SG, made up of a metal and/or plastic housing, for example, has an interface IF as an integrated module or part of a system ASIC. A crash sensor system US, which is situated outside control unit SG, is connected to this interface. This crash sensor system US may have a plurality of sensors, e.g., acceleration sensors, structure-borne noise sensors, air pressure sensors, surroundings sensors, and other relevant sensors to ascertain a dangerous situation. Transmission of the data from crash sensor system US may take place via a bus or via a point-to-point connection. A current interface, which has proven to be particularly robust, is normally used for this purpose. Interface IF formats the data, which stem from crash sensor system US, into a format readable for microcontroller μC as the analyzer circuit. It is possible that at least parts of the crash sensor system are also situated inside control unit SG.

The sensor signal of crash sensor system US is thus provided to analyzer circuit μC by interface IF. Features are obtained in feature module M from the sensor signal, such as, for example, the acceleration and/or the velocity from the acceleration signal as the sensor signal. Module D forms a difference between a feature vector, formed of the features, and a threshold value. This difference is weighted and signal-processed in a weighting module G so that comparator module V compares this signal-processed difference, which has also been weighted, with a further threshold value to ascertain whether or not an activating case exists. If this is not the case, nothing happens; however, if it is the case then the activation of the passenger protection means is directed so that the activation circuit FLIC, which, for example, may be part of a system ASIC for control unit SG, appropriately activates the passenger protection means, also via wireless communication, for example.

It is thus characteristic that a threshold value comparison is executed twice. This is explained in greater detail in FIG. 2 in the flow chart of the method according to the present invention. Acceleration 101 and velocity decrease 102, labeled with a and dv respectively, are entered as input variables into block 103 in which the first threshold value comparison takes place. A vector is formed from acceleration 101 and velocity decrease 102 and this vector is compared with a predefined threshold value. The difference between the vector and the threshold value is formed. This is referred to as output signal 104. Output signal 104 is weighted in block 105 as a function of the acceleration, for example. Signal 106 thus weighted is integrated once or twice in integration block 107.

Integrated weighted difference 108 is forwarded to a further threshold value comparison 110, where signal 108 is compared with threshold value 109. It is possible to devise this threshold value 109 to be changeable over time or as a function of a feature. As stated, signal 108 exceeds this second threshold value 109. Therefore an activating case exists since both threshold values 103 and 109 have been exceeded.

If it has already been ascertained in method step 103 that there is no positive difference between the threshold value and the feature vector, then the method is aborted at this point.

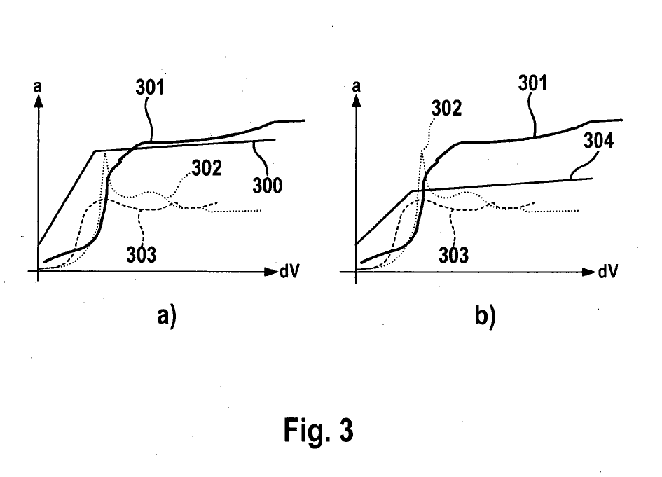

FIG. 3 explains in the acceleration/velocity diagrams A and B the effect which the method according to the present invention has on the activating performance. Diagram A shows the case prior to the implementation of the present invention. Threshold 300 is set relatively high, so that fire crash 301 exceeds this threshold only very late. No-fire crashes 302 and 303 cannot exceed this robust threshold 300.

However, diagram B shows that threshold 304 is now set lower, so that both fire crash 301 and no-fire crash 302 exceed threshold 304. In turn, no-fire crash 303 also cannot exceed this threshold 304. However, since no-fire crash 302 exceeds threshold 304 only once and then falls short again, no crash exists presently.

1-10. (canceled)

11. A method for activating a passenger protection arrangement for a vehicle, comprising:
obtaining at least one vehicle dynamics feature from at least one sensor signal of a crash sensor system;
forming a feature vector based on the at least one vehicle dynamics feature;
forming a difference between the feature vector and a first threshold value;
weighting the difference as a function of at least one weighting feature;
deriving a weighted variable based on the weighted difference; and
activating the passenger protection arrangement as a function of a comparison between the weighted variable and a second threshold value.

12. The method as recited in claim 11, wherein the weighted variable is generated by integrating the weighted difference.

13. The method as recited in claim 11, wherein the weighting includes multiplying the difference with the weighting feature.

14. The method as recited in claim 11, wherein the second threshold value is variably selected as a function of at least one of a selected vehicle dynamics feature and time.

15. The method as recited in claim 11, wherein the feature vector is formed based an vehicle acceleration and velocity.

16. The method as recited in claim 13, wherein the vehicle acceleration is used as the at least one weighting feature.

17. The method as recited in claim 11, wherein the first threshold value distinguishes between an activating situation and a non-activating situation for the passenger protection arrangement.

18. The method as recited in claim 11, wherein the first threshold value distinguishes between two different crash types.

19. The method as recited in claim 11, wherein the first threshold value distinguishes between two different crash severity levels.

20. A control unit for activating a passenger protection arrangement for a vehicle, comprising:
an interface configured to provide at least one sensor signal generated by a crash sensor system;
an analyzer circuit including:
a feature module configured to generate at least one vehicle dynamics feature from the at least one sensor signal and form a feature vector based on the at least one vehicle dynamics feature;
a difference module configured to form a difference between the feature vector and a first threshold value;
a weighting module configured to weight the difference as a function of at least one weighting feature; and
a comparator module configured to compare a variable derived from the weighted difference to a second threshold value; and
an activating circuit configured to activate the passenger protection arrangement as a function of the comparison with the second threshold value.
